(19) United States
(12) Patent Application Publication
(10) Pub. No.: US 2015/0154119 A1
(43) Pub. Date: Jun. 4, 2015

(54) MEMORY ALLOCATION AND PAGE ADDRESS TRANSLATION SYSTEM AND METHOD

(71) Applicant: NATIONAL TAIWAN UNIVERSITY, TAIPEI (TW)

(72) Inventors: Yuan-Cheng LEE, Taipei City (TW); Chih-Wen HSUEH, Taipei City (TW)

(73) Assignee: NATIONAL TAIWAN UNIVERSITY, TAIPEI (TW)

(21) Appl. No.: 14/262,810

(22) Filed: Apr. 28, 2014

(30) Foreign Application Priority Data
Dec. 4, 2013 (TW) 102144418

(51) Int. Cl. G06F 12/10

(52) U.S. Cl. CPC G06F 12/1009; G06F 12/1027

(57) ABSTRACT

A memory allocation and page address translation system includes a buddy memory allocator, a plurality of guest page tables, a memory management unit and a buddy translation lookaside buffer. The buddy memory allocator is configured for allocating machine physical memory space to a virtual machine monitor and a plurality of virtual machines. Each of the virtual machine monitor and the virtual machines receives memory chunks with different sizes. The guest page tables are configured for providing virtual address translation references for the virtual machine monitor and the virtual machines. The memory management unit is configured for translating a virtual address into a guest physical address. The buddy translation lookaside buffer is configured for translating the guest physical address into a machine physical address.

### RELATED APPLICATIONS

This application claims priority to Taiwanese Application Serial Number 102144418 filed Dec. 4, 2013, the entirety of which is herein incorporated by reference.

### BACKGROUND

1. Technical Field

The present disclosure relates to a memory allocation and page address translation system. More particularly, the present disclosure relates to a memory allocation and page address translation system and method executed in virtual environments.

2. Description of Related Art

The conventional memory management in virtual environments adopts two-stage page address translations. Therefore, the hardware resources required by the two-stage page address translations in virtual environments are around twice the hardware resources required by the page address translations in non-virtual environments. As a result, the area, design, cost and power consumption of hardware chips for executing the two-stage page address translations in virtual environments are greatly increased. Such reasons make it more challenging for mobile devices to support virtual environments.

Moreover, the time delay of conventional two-stage page address translations is not only long, but also hard to predict (that is, the uncertainty of time delay is larger). Since most functions and applications of mobile devices require real-time computations, the long time delay and the increasing uncertainty thereof make the software designs for the real-time functions or applications more complicated.

### SUMMARY

In one aspect, the present disclosure is related to a memory allocation and page address translation system. The memory allocation and page address translation system includes a buddy memory allocator, a plurality of guest page tables, a memory management unit and a buddy translation lookaside buffer. The buddy memory allocator is configured for dividing machine physical memory space into a plurality of memory chunks, in which the size of each of the memory chunks is a power of two. The buddy memory allocator is further configured for allocating the memory chunks to a virtual machine monitor and a plurality of virtual machines managed by the virtual machine monitor, so that one or more different sized chunks selected from the memory chunks are allocated to each of the virtual machine monitor and the virtual machines. The guest page tables provide virtual address translation references for the virtual machine monitor and the virtual machines. The memory management unit is configured for translating a virtual address of the virtual machine monitor or of the virtual machines into a guest physical address according to the guest page tables. The buddy translation lookaside buffer is configured for translating the guest physical address into a machine physical address.

According to one embodiment of the present disclosure, the abovementioned memory allocation and page address translation system further includes a page walk cache, in which the memory management unit is further configured for selectively caching page descriptors by utilizing the page walk cache.

According to one embodiment of the present disclosure, the abovementioned memory allocation and page address translation system further includes a translation lookaside buffer, in which the memory management unit is further configured for selectively translating the virtual address into the machine physical address by utilizing the translation lookaside buffer.

According to one embodiment of the present disclosure, the abovementioned buddy translation lookaside buffer has a plurality of translation entries, in which each of the translation entries provides a translation mapping between the guest physical address and the machine physical address.

According to one embodiment of the present disclosure, each of the abovementioned translation entries includes a virtual machine identifier field, a guest physical address field, a mask size field, a machine physical address field, a present field, a global mapping field and a permission field. The virtual machine identifier field specifies the virtual machine of a guest physical address to be compared. The guest physical address field specifies the prefix of the guest physical address to be compared. The mask size field specifies the size of the prefix of the guest physical address to be compared. The machine physical address field specifies the starting address of a corresponding machine physical address. The present field specifies whether the translation entry is effective. The global mapping field specifies whether the translation entry is a global mapping. The permission field specifies whether a corresponding machine physical memory chunk is accessible.

In another aspect, the present disclosure is related to a memory allocation and page address translation method. The memory allocation and page address translation method includes utilizing a buddy memory allocator to divide a machine physical memory space into a plurality of memory chunks in which the size of each of the memory chunks is a power of two; utilizing the buddy memory allocator to allocate the memory chunks to a virtual machine monitor and a plurality of virtual machines managed by the virtual machine monitor, so that one or more different sized chunks selected from the memory chunks are allocated to each of the virtual machine monitor and the virtual machines; translating a virtual address of the virtual machine monitor or of the virtual machines into a guest physical address according to a plurality of guest page tables; and utilizing a buddy translation lookaside buffer to translate the guest physical address into a machine physical address.

According to one embodiment of the present disclosure, the step of translating the virtual address into the guest physical address according to the guest page tables includes selectively caching page descriptors by utilizing a page walk cache.

According to one embodiment of the present disclosure, the step of translating the virtual address into the guest physical address according to the guest page tables includes selectively translating the virtual address into the machine physical address by utilizing a translation lookaside buffer.

According to one embodiment of the present disclosure, the abovementioned buddy translation lookaside buffer has a plurality of translation entries, in which each of the translation entries provides a translation mapping between the guest physical address and the machine physical address.

According to one embodiment of the present disclosure, each of the abovementioned translation entries includes a virtual machine identifier field, a guest physical address field, a mask size field, a machine physical address field, a present field, a global mapping field and a permission field. The virtual machine identifier field specifies the virtual machine of a guest physical address to be compared. The guest physical address field specifies the prefix of the guest physical address to be compared. The mask size field specifies the size of the prefix of the guest physical address to be compared. The machine physical address field specifies the starting address of a corresponding machine physical address. The present field specifies whether the translation entry is effective. The global mapping field specifies whether the translation entry is a global mapping. The permission field specifies whether a corresponding machine physical memory chunk is accessible.

One advantage of the present disclosure is that by utilizing a novel buddy memory allocator and a novel buddy translation lookaside buffer with a 100% hit ratio, the number of times memory access is required by page address translations is reduced. Therefore, the time required by page address translations and the uncertainty of the time delay of page address translations are also reduced.

Moreover, compared with the conventional two-stage page address translation system, the memory allocation and page address translation system of the present disclosure requires less hardware units and therefore the design complexity of hardware chips is reduced.

These and other features, aspects, and advantages of the present disclosure will become better understood with reference to the following description and appended claims.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the 0 lowing detailed description of the embodiment, with reference made to the accompanying drawings as follows:

FIG. 1 is a schematic diagram of a memory allocation and page address translation system in accordance with one embodiment of the present disclosure;

FIG. 2 is a schematic diagram explaining how a buddy memory allocator allocates memory chunks to a virtual machine monitor and virtual machines in accordance with an example of one embodiment of the present disclosure;

FIG. 3 is a schematic diagram explaining how a memory management unit and a buddy translation lookaside buffer translate a virtual address into a corresponding guest physical address and a corresponding machine physical address in accordance with one embodiment of the present disclosure;

FIG. 4 is a schematic diagram explaining how a memory management unit and a buddy translation lookaside buffer translate a virtual address into a corresponding guest physical address and a corresponding machine physical address in accordance with one embodiment of the present disclosure;

FIG. 5 is a schematic diagram explaining how a memory management unit and a buddy translation lookaside buffer translate a virtual address into a corresponding guest physical address and a corresponding machine physical address in accordance with one embodiment of the present disclosure; and

FIG. 6 is a flow chart of a memory allocation and page address translation method in accordance with one embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

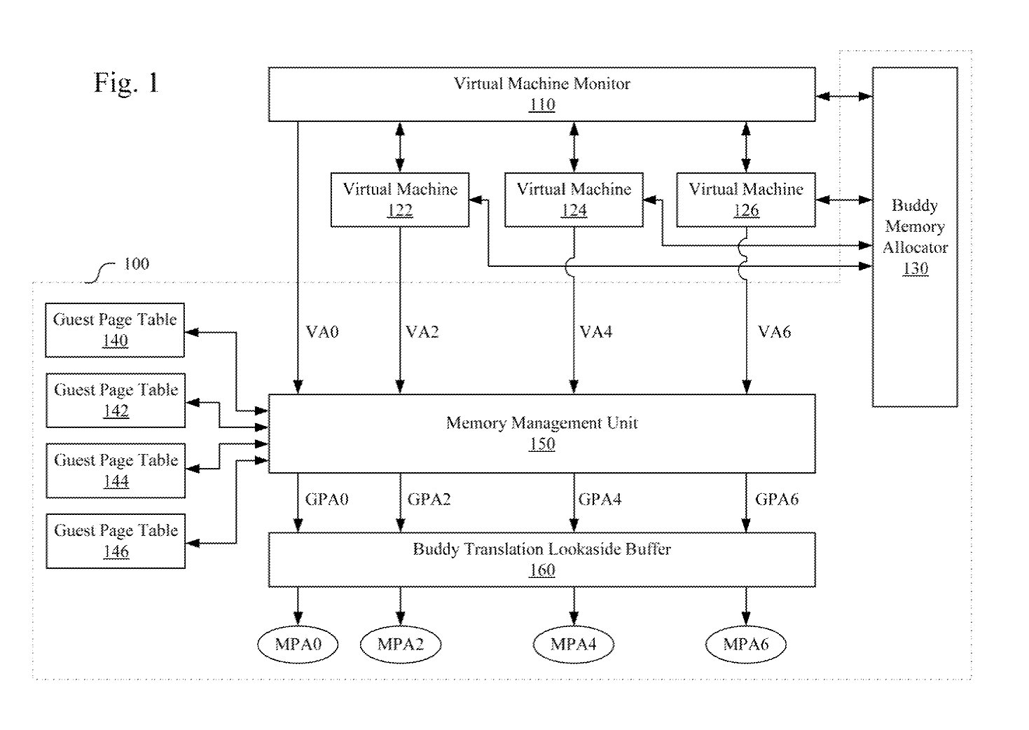

Reference is made first to FIG. 1. FIG. 1 is a schematic diagram of a memory allocation and page address translation system 100 in accordance with one embodiment of the present disclosure. The memory allocation and page address translation system 100 includes a buddy memory allocator 130, a plurality of guest page tables 140, 142, 144 and 146, a memory management unit 150 and a buddy translation lookaside buffer 160. In an embodiment of the present disclosure, the memory allocation and page address translation system 100 is applied in an electronic device (for example, a smartphone, a tablet computer, a laptop or a personal computer).

The memory allocation and page address translation system 100 is configured for allocating machine physical memory space to a virtual machine monitor 110 and virtual machines 122, 124, 126 managed by the virtual machine monitor 110. The memory allocation and page address translation system 100 is further configured for translating virtual addresses VA0, VA2, VA4 and VA6 of the virtual machine monitor 110 and the virtual machines 122, 124, 126 into corresponding guest physical addresses GPA0, GPA2, GPA4 and GPA6, and into corresponding machine physical addresses MPA0, MPA2, MPA4 and MPA6.

In an embodiment of the present disclosure, the virtual machine monitor 110 can be an independent operating system, or a computer program running on a Linux operating system, a Macintosh operating system, an Android operating system, an iOS operating system or a Windows operating system. Each of the virtual machines 122, 124 and 126 can be any operating system that is managed by the abovementioned operating systems or a computer program. It is to be noted that the number of the virtual machines is not limited to three, and a user can increase or decrease the number of the virtual machines according to actual needs.

The buddy memory allocator 130 is configured for dividing the machine physical memory space into a plurality of memory chunks, in which the size of each of the memory chunks is a power of two. The buddy memory allocator 130 is further configured for allocating the memory chunks to the virtual machine monitor 110 and the virtual machines 122, 124 and 126 managed by the virtual machine monitor 110, so that one or more different sized chunks selected from the memory chunks are allocated to each of the virtual machine monitor 110 and the virtual machines 122, 124 and 126. In the following paragraph, an example will be given to further explain the operation of the buddy memory allocator 130.

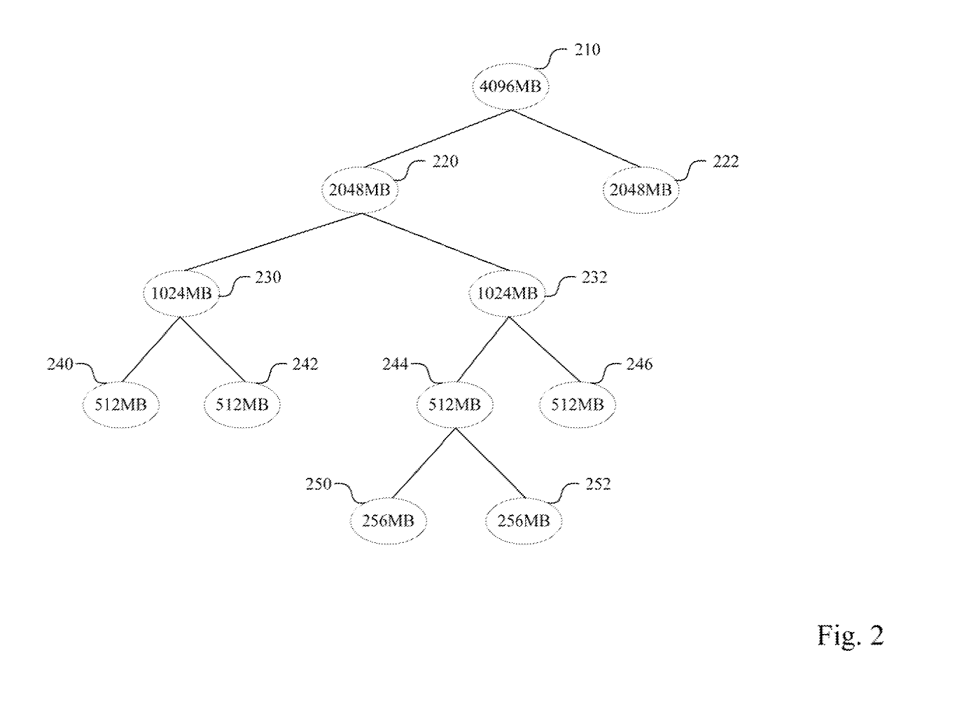

Reference is made also to FIG. 2. FIG. 2 is a schematic diagram explaining how the buddy memory allocator 130 allocates the memory chunks to the virtual machine monitor 110 and the virtual machines 122, 124 and 126 in accordance with an example of the present embodiment. In this example, the buddy memory allocator 130 is configured for allocating machine memory space 210 with a size of 4 GB (4096 MB) illustrated in FIG. 2 to the virtual machine monitor 110 and the virtual machines 122, 124 and 126 according to the memory space requirements illustrated in Table 1.

TABLE 1

| | virtual | | | |
|---|---|---|---|---|
| | machine | virtual | virtual | virtual |
| | monitor | machine | machine | machine |
| | 110 | 122 | 124 | 126 |
| Memory | 512 MB | 2048 MB | 768 MB | 768 MB |
| space | | | | |
| requirement | | | | |

The buddy memory allocator 130 first allocates the memory chunks to the virtual machine monitor 110 according to the memory space requirement of the virtual machine monitor 110 (which is 512 MB). To do this, the buddy memory allocator 130 first divides the machine physical space 210 (with a size of 4096 MB) to two memory chunks 220 and 222 (the size of each of which is 2048 MB). Since the memory requirement of the virtual machine monitor 110 is less than 2048 MB, the buddy memory allocator 130 then divides the memory chunk 220 to two memory chunks 230 and 232 (the size of each of which is 1024 MB). Since the memory requirement of the virtual machine monitor 110 is still less than 1024 MB, the buddy memory allocator 130 then divides the memory chunk 230 into two memory chunks 240 and 242, and allocates the memory chunk 240 (with a size of 512 MB) to the virtual machine monitor 110.

The buddy memory allocator 130 then allocates the memory chunk 222 (with a size of 2048 MB) to the virtual machine 122 according to the memory space requirement of the virtual machine 122 (which is 2048 MB).

Subsequently, the buddy memory allocator 130 allocates the memory chunks to the virtual machine 124 according to the memory space requirement of the virtual machine 124 (which is 768 MB). The buddy memory allocator 130 first allocates the memory chunk 242 (with a size of 512 MB) to the virtual machine 124 (the virtual machine 124 still requires an extra memory space with a size of 256 MB). The buddy memory allocator 130 then divides the memory chunk 232 into two memory chunks 244 and 246 (the size of each of which is 512 MB). Since the size of the extra memory space required by the virtual machine 124 (256 MB) is less than 512 MB, the buddy memory allocator 130 then divides the memory chunk 244 into two memory chunks 250 and 252 (the size of each of which is 256 MB), and allocates the memory chunk 250 (with a size of 256 MB) to the virtual machine 124. It is to be noted that the two memory chunks allocated to the virtue machine 124 (memory chunks 242 and 250) have different sizes (which are 512 MB and 256 MB, respectively).

The buddy memory allocator 130 then allocates the memory chunk 246 (with a size of 512 MB) and the memory chunk 252 (with a size of 256 MB) to the virtual machine 126 according to the memory space requirement of the virtual machine 126 (which is 768 MB). It is to be noted that the size of each of the memory chunks illustrated in FIG. 2 is a power of two (in units of MB), and the two memory chunks allocated to the virtue machine 126 (memory chunks 246 and 252) have different sizes (which are 512 MB and 256 MB, respectively).

The guest page tables 140, 142, 144 and 146 illustrated in FIG. 1 are utilized for providing virtual address translation references for the virtual machine monitor 110 and the virtual machines 122, 124 and 126.

The memory management unit 150 is configured for translating a virtual address VA0 of the virtual machine monitor 110, or a virtual address VA2, VA4 or VA6 of the virtual machine 122, 124 or 126 into a corresponding guest physical address GPA0, GPA2, GPA4 or GPA 6 according to the guest page tables 140, 142, 144 and 146.

The buddy translation lookaside buffer 160 is configured for translating the guest physical address GPA0, GPA2, GPA4 or GPA 6 into a corresponding machine physical address MPA0, MPA2, MPA4 or MPA6. In the following paragraph, the operation of the memory management unit 150 and the buddy translation lookaside buffer 160 will be further explained.

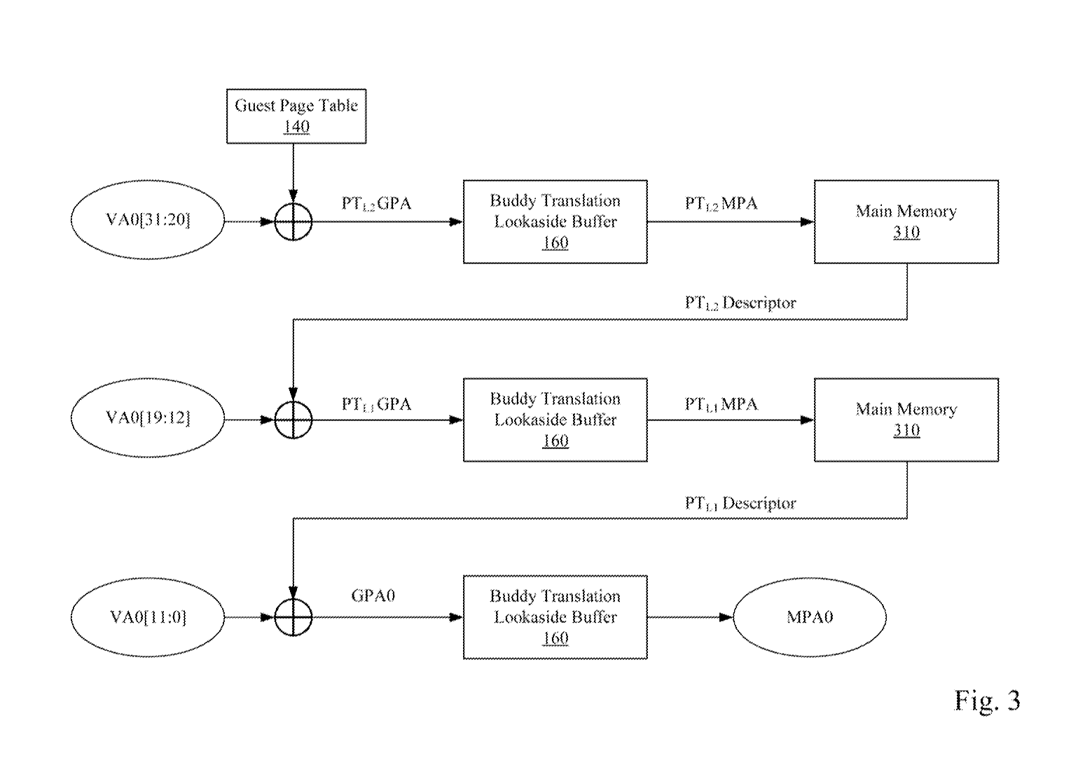

Additional reference is made to FIG. 3. FIG. 3 is a schematic diagram explaining how the memory management unit 150 and the buddy translation lookaside buffer 160 translate the virtual address VA0 into the corresponding guest physical address GPA0 and the corresponding machine physical address MPA0 in accordance with the present embodiment. In the present embodiment, VA0 is a 32-bit binary value. VA0[11:0] represents the first 12 bits of VA0, VA0[19:12] represents the 8 bits following VA0[11:0] of VA0, and VA0[31:20] represents the 12 bits following VA0[19:12] of VA0.

In this embodiment, the memory management unit 150 first references the guest page table 140 (the guest page table 140 corresponds to the virtual machine monitor 110) according to VA0[31:20] and obtains a corresponding second level page descriptor guest physical address PT_{L2}GPA. The memory management unit 150 then transmits PT_{L2} to the buddy translation lookaside buffer 160. The buddy translation lookaside buffer 160 translates PT_{L2} GPA into a corresponding second level page descriptor machine physical address PT_{L2}MPA. The memory management unit 150 then reads a corresponding second level page descriptor PT_{L2}Descriptor from a main memory 310 according to PT_{L2} MPA.

The memory management unit 150 then references the second level page descriptor PT_{L2} Descriptor according to VA0[19:12], and obtains a corresponding first level page descriptor guest physical address PT_{L1} GPA. The memory management unit 150 then transmits PT_{L1} GPA to the buddy translation lookaside buffer 160. The buddy translation lookaside buffer 160 translates PT_{L1} GPA into a corresponding first level page descriptor machine physical address PT_{L1} MPA. The memory management unit 150 then reads a corresponding first level page descriptor PT_{L1} Descriptor from the main memory 310 according to PT_{L1} MPA.

Next, the memory management unit 150 computes the guest physical address GPA0 corresponding to virtual address VA0 according to VA0[11:0] and the first level page descriptor PT_{L1} Descriptor. The memory management unit 150 then transmits GPA0 to the buddy translation lookaside buffer 160. The buddy translation lookaside buffer 160 translates the guest physical address GPA0 into the corresponding machine physical address MPA0.

The operation of translating the virtual addresses VA2, VA4 and VA6 of the virtual machines 122, 124 and 126 into the corresponding guest physical addresses GPA2, GPA4 and GPA6 and into the corresponding machine physical addresses MPA2, MPA4 and MPA6 by the memory management unit 150 and the buddy translation lookaside buffer 160 is similar, and hence is not explained again herein.

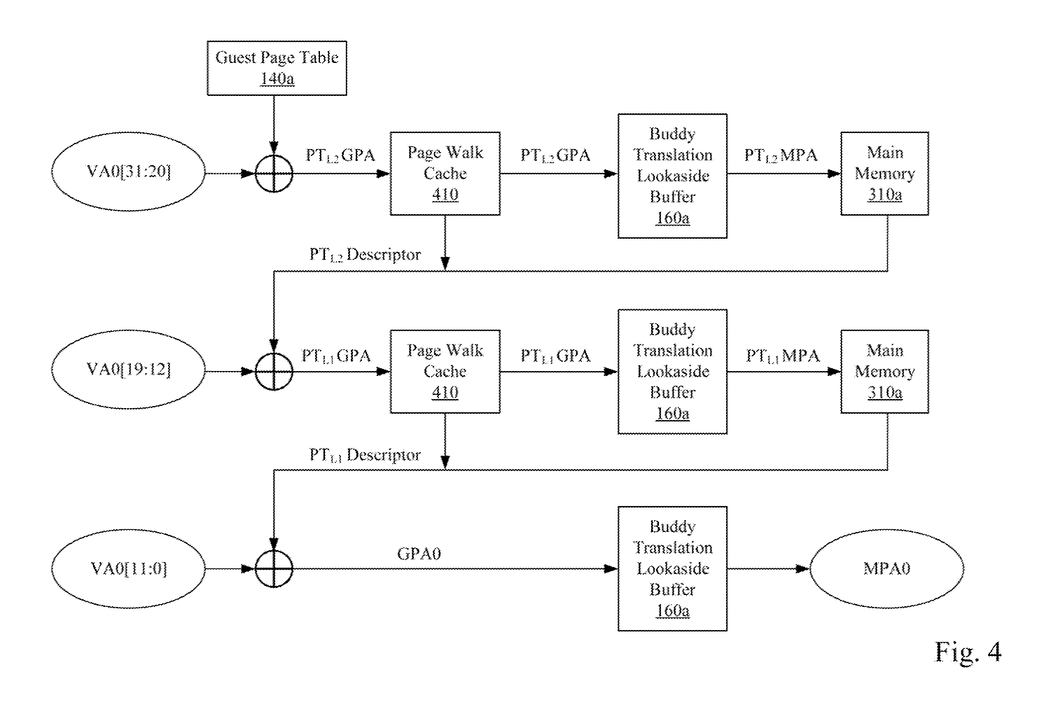

Reference is now made to FIG. 4. FIG. 4 is a schematic diagram explaining how a memory management unit and a buddy translation lookaside buffer 160a translate the virtual address VA0 into the corresponding guest physical address GPA0 and the corresponding machine physical address MPA0 in accordance with one embodiment of the present disclosure.

Compared with the embodiment illustrated in FIG. 3, in this embodiment, the memory management unit is further configured for selectively caching page descriptors by utilizing a page walk cache 410.

As illustrated in FIG. 4, the memory management unit first references the page walk cache 410 according to the second level page descriptor guest physical address PT_{L2}GPA. If the second level page descriptor PT_{L2} Descriptor corresponding to PT_{L2} GPA exists in the page walk cache 410, the memory management unit reads PT_{L2} Descriptor from the page walk cache 410. On the other hand, if the second level page descriptor PT_{L2} Descriptor corresponding to PT_{L2}GPA does not exist in the page walk cache 410, the memory management unit transmits PT_{L2}GPA to the buddy translation lookaside buffer 160a and the operation illustrated in FIG. 3 is performed to read PT_{L2} Descriptor from a main memory 310a.

As illustrated in FIG. 4, the memory management unit then references the page walk cache 410 according to the first level page descriptor guest physical address PT_{L1} GPA. If the first level page descriptor PT_{L1} Descriptor corresponding to PT_{L1}GPA exists in page walk cache 410, the memory management unit reads PT_{L1} Descriptor from page walk cache 410. On the other hand, if the first level page descriptor PT_{L1} Descriptor corresponding to PT_{L1} GPA does not exist in page walk cache 410, the memory management unit transmits PT_{L1} GPA to the buddy translation lookaside buffer 160a and the operation illustrated in FIG. 3 is performed to read PT_{L1} Descriptor from the main memory 310a.

Except for the operation regarding the page walk cache 410, other operations in the embodiment illustrated in FIG. 4 are similar to the operations described with reference to FIG. 3, and hence are not explained again herein.

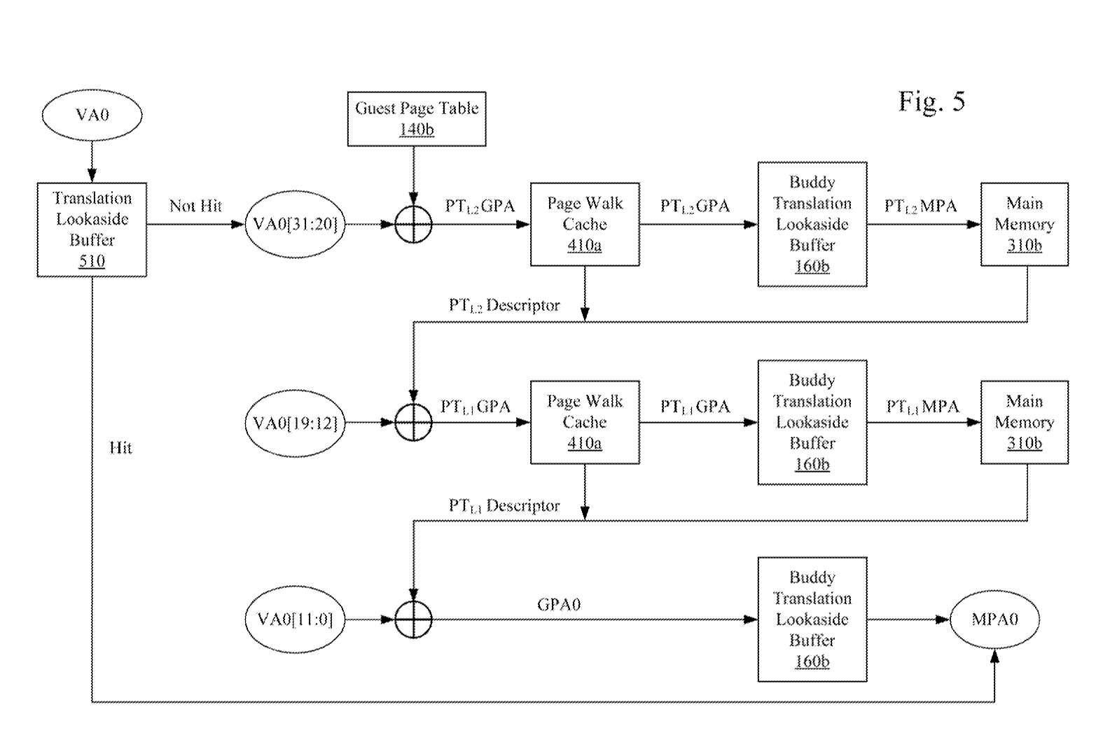

Reference is now made to FIG. 5. FIG. 5 is a schematic diagram explaining how a memory management unit and a buddy translation lookaside buffer 160b translate the virtual address VA0 into the corresponding guest physical address GPA0 and the corresponding machine physical address MPA0 in accordance with one embodiment of the present disclosure.

Compared with the embodiment illustrated in FIG. 4, in this embodiment, the memory management unit is further configured for selectively translating the virtual address VA0 into the machine physical address MPA0 by utilizing the translation lookaside buffer 510.

As illustrated in FIG. 5, the memory management unit first transmits the virtual address VA0 to the translation lookaside buffer 510. If the mapping between VA0 and MPA0 is stored in the translation lookaside buffer 510 (that is, the mapping between VA0 and MPA0 is stored in the translation lookaside buffer 510), the translation lookaside buffer 510 outputs MPA0. If the mapping between VA0 and MPA0 is not stored in the translation lookaside buffer 510, the memory management unit performs the operation illustrated in FIG. 4.

In an embodiment of the present disclosure, the buddy translation lookaside buffer has a plurality of translation entries, in which each of the translation entries provides a translation mapping between a guest physical address and a machine physical address. Each of the translation entries includes a virtual machine identifier (VMID) field, a guest physical address (GPA) field, a mask size (SZ) field, a machine physical address (MPA) field, a present (P) field, a global mapping (G) field and a permission field (PERM).

The virtual machine identifier (VMID) field specifies the virtual machine of a guest physical address to be compared. The guest physical address (GPA) field specifies the prefix of the guest physical address to be compared. The mask size (SZ) field specifies the size of the prefix of the guest physical address to be compared. The machine physical address (MPA) field specifies the starting address of a corresponding machine physical address. The present (P) field specifies whether the translation entry is effective, if the value of the present field of a translation entry is 0, the translation entry will not be compared. The global mapping (G) field specifies whether the translation entry is a global mapping. If the value of the global mapping field of a translation entry is 1, the virtual machine identifier (VMID) field of the translation entry will not be compared. The permission (PERM) field specifies whether a corresponding machine physical memory chunk is accessible. In the present embodiment, the permission field is a 4-digit binary value, in which the first digit of the permission field specifies whether the corresponding machine physical memory chunk is readable for the virtual machine monitor. The second digit of the permission field specifies whether the corresponding machine physical memory chunk is writable for the virtual machine monitor. The third digit of the permission field specifies whether the corresponding machine physical memory chunk is readable for the virtual machine. The fourth digit of the permission field specifies whether the corresponding machine physical memory chunk is writable to the virtual machine.

Table 2 below is a list of the translation entries of the buddy translation lookaside buffer in accordance with one embodiment of the present disclosure. In this embodiment, the buddy memory allocator first allocates a machine physical memory space with a size of 4 GB to a virtual machine monitor 110c and virtual machines 122c, 124c and 126c according to the memory space requirements illustrated in FIG. 3 (the operation of how the buddy memory allocator allocates the memory chunks is similar to the operation described with reference to FIG. 2 and hence is not explained again herein).

Subsequently, the buddy translation lookaside buffer creates the list of the translation entries, as illustrated in Table 2, according to the result of the abovementioned allocation. In the present embodiment, both GPA and MPA are 32-bit binary values (which may be expressed as the 8-bit hexadecimal values as illustrated in Table 2), and the VMID of the virtual machine monitor 110c and the virtual machines 122c, 124c and 126c are 0, 1, 2 and 3, respectively.

TABLE 2

| VMID | GPA | SZ | MPA | P | G | PERM |
|---|---|---|---|---|---|---|
| X | E000_0000 | 3 | 0000_0000 | 1 | 1 | 1110 |
| 1 | 0000_0000 | 1 | 8000_0000 | 1 | 0 | 1111 |
| 2 | 0000_0000 | 3 | 2000_0000 | 1 | 0 | 1111 |
| 2 | 2000_0000 | 4 | 4000_0000 | 1 | 0 | 1111 |
| 3 | 0000_0000 | 3 | 6000_0000 | 1 | 0 | 1111 |
| 3 | 2000_0000 | 4 | 5000_0000 | 1 | 0 | 1111 |

TABLE 3

| | virtual | | | |
|---|---|---|---|---|
| | machine | virtual | virtual | virtual |
| | monitor | machine | machine | machine |
| | 110c | 122c | 124c | 126c |
| Memory | 512 MB | 2048 MB | 768 MB | 768 MB |
| space | | | | |
| requirement | | | | |

The buddy translation lookaside buffer first creates the translation entry illustrated in row 1 of Table 2 for the virtual machine monitor 110, in which the translation entry is a global mapping (G=1) and hence the VMID of this entry is set to be X (it is not necessary to compare VMID for this translation entry). The permission (PERM) field of this translation entry is 1110 (i.e., the machine physical memory chunk corresponding to this translation entry is readable and writable for the virtual machine monitor 110c, and the machine physical memory chunk corresponding to this translation entry is readable but not writable for the virtual machines 122c, 124c and 126c).

Next, the buddy translation lookaside buffer creates the translation entry illustrated in row 2 of Table 2 for the virtual machine 122c, in which the translation entry is not a global mapping (G=0) and the VMID of this entry is set to be 1 (i.e., the VMID of the virtual machine 122c). The permission (PERM) field of this translation entry is 1111 (i.e., the machine physical memory chunk corresponding to this translation entry is readable and writable for the virtual machine monitor 110c and the virtual machines 122c, 124c and 126c).

The buddy translation lookaside buffer then creates the translation entry illustrated in row 3 and row 4 of Table 2 for the virtual machine 124c (the VMID of the virtual machine 124c is 2), and creates the translation entry illustrated in row 5 and row 6 of Table 2 for the virtual machine 126c (the VMID of the virtual machine 126c is 3). In the following paragraph, an example will be given to explain how the buddy translation lookaside buffer translates the guest physical address into the machine physical address in this embodiment according to Table 2.

In an example, a guest physical address GPA4₁=1234_{—}5000 from the virtual machine 124c (the VMID of the virtual machine 124c is 2) is transmitted to the buddy translation lookaside buffer. Since GPA4₁=0001_{—}234_{—}5000, the first 3 binary prefix digits of GPA4₁ is 000. That is, GPA4₁ hits row 3 of Table 2 (SZ of the translation entry is 3 and the first 3 binary prefix digits of GPA of the translation entry is 000). The buddy translation lookaside buffer translates GPA4₁ into 2000_{—}0000+1234_{—}5000=3234_{—}5000 accordingly.

In another example, a guest physical address GPA4₂=2234_{—}5000 from the virtual machine 124c (the VMID of the virtual machine 124c is 2) is transmitted to the buddy translation lookaside buffer. Since GPA4₂=0010_{—}2345000, the first 4 binary prefix digits of GPA4₂ is 0010. That is, GPA4₁ hits row 4 of Table 2 (SZ of the translation entry is 4 and the first 4 binary prefix digits of GPA of the translation entry is 0010). The buddy translation lookaside buffer translates GPA4₂ into 4000_{—}0000+0234_{—}5000=4234_{—}5000 accordingly.

It can be mathematically proven that by applying the memory allocation and page address translation system of the present disclosure, a buddy translation lookaside buffer with a 100% hit ratio may be realized by setting k×┌(l−log₂ k)┐ translation entries in the buddy translation lookaside buffer, in which k is the sum of the number of the virtual machines and the virtual machine monitor, and l is the number of distinct memory chunks allocated to the virtual machines and the virtual machine monitor by the buddy memory allocator.

In the present disclosure, by utilizing a novel buddy memory allocator and a novel buddy translation lookaside buffer with a 100% hit ratio, the number of times memory access is required by page address translations is reduced. Therefore the time required by page address translations and the uncertainty of the time delay of page address translations are reduced.

It may be seen from simulation results that, compared with the conventional two-stage page address translation system, by utilizing the memory allocation and page address translation system of the present disclosure, the number of times memory access is required by page address translations may be reduced by 51.37% to 56.01%, and therefore the time required by page address translations and the uncertainty of the time delay of page address translations may be greatly reduced.

Moreover, compared with the conventional two-stage page address translation system, the memory allocation and page address translation system of the present disclosure requires less hardware units and therefore the design complexity of hardware chips is reduced.

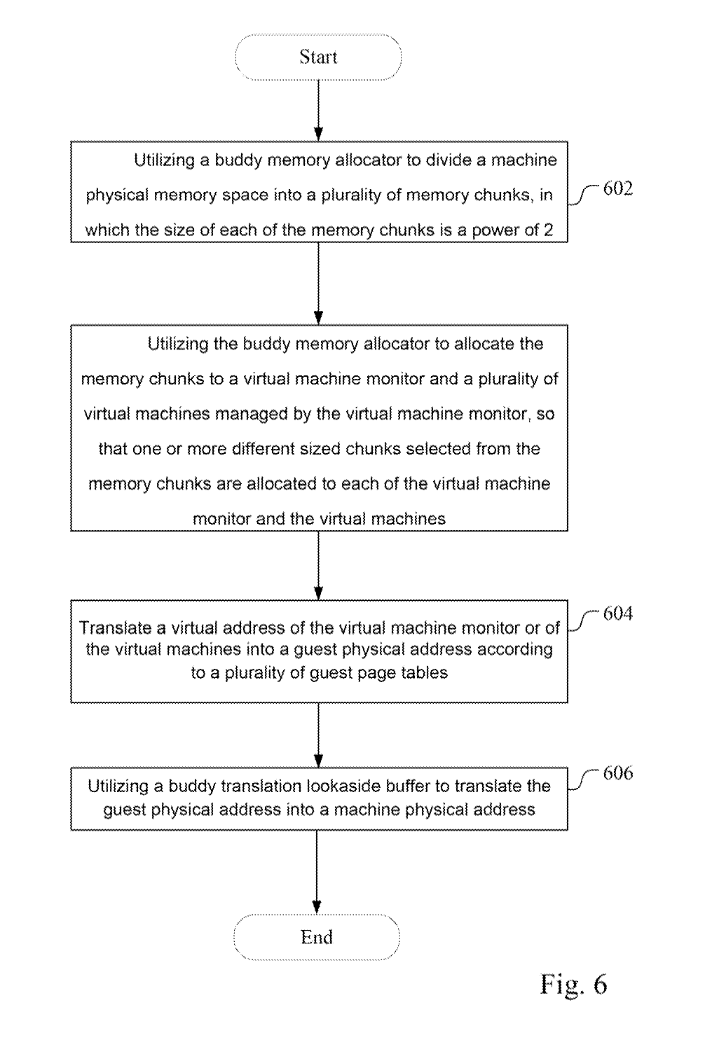

Reference is now made to FIG. 6. FIG. 6 is a flow chart of a memory allocation and page address translation method in accordance with one embodiment of the present disclosure. The memory allocation and page address translation method may be implemented by the memory allocation and page address translation system 100 illustrated in FIG. 1, but is not limited in this regard. For convenience and clarity, it is assumed that the memory allocation and page address translation method is implemented by the memory allocation and page address translation system 100 illustrated in FIG. 1.

In step 602, the buddy memory allocator 130 is utilized to divide a machine physical memory space into a plurality of memory chunks, in which the size of each of the memory chunks is a power of two.

In step 603, the buddy memory allocator 130 is utilized to allocate the memory chunks to the virtual machine monitor 110 and the virtual machines 122, 124 and 126 managed by the virtual′ machine monitor 110, so that one or more different sized chunks selected from the memory chunks are allocated to each of the virtual machine monitor 110 and the virtual machines 122, 124 and 126.

In step 604, the virtual address VA0 of the virtual machine monitor 110 or the virtual address VA2, VA4 or VA6 of the virtual machines 122, 124 and 126 are translated into the corresponding guest physical address GPA0, GPA2, GPA4 or GPA6 according to the guest page tables 140, 142, 144 and 146.

In step 606, the buddy translation lookaside buffer 160 is utilized to translate the guest physical address GPA0, GPA2, GPA4 or GPA6 into the corresponding machine physical address MPA0, MPA2, MPA4 or MPA6.

It may be seen from simulation results that, compared with the conventional two-stage page address translation method, by utilizing the memory allocation and page address translation method of the present disclosure, the number of times memory access is required by page address translations may be reduced by 51.37% to 56.01%, and therefore the time required by page address translations and the uncertainty of the time delay of page address translations may be greatly reduced.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A memory allocation and page address translation system, comprising:
a buddy memory allocator configured for dividing machine physical memory space into a plurality of memory chunks, wherein the size of each of the memory chunks is a power of two, and for allocating the memory chunks to a virtual machine monitor and a plurality of virtual machines managed by the virtual machine monitor, so that one or more different sized chunks selected from the memory chunks are allocated to each of the virtual machine monitor and the virtual machines;
a plurality of guest page tables for providing virtual address translation references for the virtual machine monitor and the virtual machines;
a memory management unit configured for translating a virtual address of the virtual machine monitor or of the virtual machines into a guest physical address according to the guest page tables; and
a buddy translation lookaside buffer configured for translating the guest physical address into a machine physical address.

2. The memory allocation and page address translation system of claim 1, further comprising a page walk cache, wherein the memory management unit is further configured for selectively caching page descriptors by utilizing the page walk cache.

3. The memory allocation and page address translation system of claim 1, further comprising a translation lookaside buffer, wherein the memory management unit is further configured for selectively translating the virtual address into the machine physical address by utilizing the translation lookaside buffer.

4. The memory allocation and page address translation system of claim 1, wherein the buddy translation lookaside buffer has a plurality of translation entries, wherein each of the translation entries provides a translation mapping between the guest physical address and the machine physical address.

5. The memory allocation and page address translation system of claim 4, wherein each of the translation entries comprises:
a virtual machine identifier field specifying the virtual machine of a guest physical address to be compared;
a guest physical address field specifying the prefix of the guest physical address to be compared;
a mask size field specifying the size of the prefix of the guest physical address to be compared;
a machine physical address field specifying the starting address of a corresponding machine physical address;
a present field specifying whether the translation entry is effective;
a global mapping field specifying whether the translation entry is a global mapping; and
a permission field specifying whether a corresponding machine physical memory chunk is accessible.

6. A memory allocation and page address translation method, comprising:
utilizing a buddy memory allocator to divide a machine physical memory space into a plurality of memory chunks, wherein the size of each of the memory chunks is a power of two;
utilizing the buddy memory allocator to allocate the memory chunks to a virtual machine monitor and a plurality of virtual machines managed by the virtual machine monitor, so that one or more different sized chunks selected from the memory chunks are allocated to each of the virtual machine monitor and the virtual machines;
translating a virtual address of the virtual machine monitor or of the virtual machines into a guest physical address according to a plurality of guest page tables; and
utilizing a buddy translation lookaside buffer to translate the guest physical address into a machine physical address.

7. The memory allocation and page address translation method of claim 6, wherein the step of translating the virtual address into the guest physical address according to the guest page tables comprises:
selectively caching page descriptors by utilizing a page walk cache.

8. The memory allocation and page address translation method of claim 6, wherein the step of translating the virtual address into the guest physical address according to the guest page tables comprise:
selectively translating the virtual address into the machine physical address by utilizing a translation lookaside buffer.

9. The memory allocation and page address translation method of claim 6, wherein the buddy translation lookaside buffer has a plurality of translation entries, wherein each of the translation entries provides a translation mapping between the guest physical address and the machine physical address.

10. The memory allocation and page address translation method of claim 9, wherein each of the translation entries comprises:
a virtual machine identifier field specifying the virtual machine of a guest physical address to be compared;
a guest physical address field specifying the prefix of the guest physical address to be compared;
a mask size field specifying the size of the prefix of the guest physical address to be compared;
a machine physical address field specifying the starting address of a corresponding machine physical address;
a present field specifying whether the translation entry is effective;
a global mapping field specifying whether the translation entry is a global mapping; and
a permission field specifying whether a corresponding machine physical memory chunk is accessible.
